(19) United States
(12) Patent Application Publication
(10) Pub. No.: US 2023/0030289 A1
(43) Pub. Date: Feb. 2, 2023

(54) MANAGING FIBER OPTIC CABLE LENGTH FOR DOWNHOLE SPLICING IN A WELLBORE

(71) Applicant: Halliburton Energy Services, Inc., Houston, TX (US)

(72) Inventors: John Laureto Maida, Houston, TX (US); Michael Allen Becker, Houston, TX (US); Exean Kwrisnash Romero Mora, Houston, TX (US); Michel LeBlanc, Houston, TX (US); Cole Aaron Grandjean, Houston, TX (US)

(21) Appl. No.: 17/391,505

(22) Filed: Aug. 2, 2021

(51) Int. Cl. G02B 6/50; G02B 6/255

(52) U.S. Cl. CPC G02B 6/502; G02B 6/2558; G02B 6/4446

(57) ABSTRACT

A system may include a splice housing positioned along a portion of tubing in a wellbore and a splice housing protector around the splice housing. An uphole fiber optic cable may extend through the splice housing protector. The uphole fiber optic cable may mate with a first port of the splice housing at a downhole end of the splice housing protector. A downhole fiber optic cable may mate with a second port of the splice housing in the splice housing protector. The splice housing may splice the uphole fiber optic cable and the downhole fiber optic cable.

### TECHNICAL FIELD

The present disclosure relates generally to wellbore operations and, more particularly (although not necessarily exclusively), to performing fiber optic cable splicing operations on fiber optic cables within the wellbore.

### BACKGROUND

Fiber optic cables may be installed within a wellbore for performing various sensing operations within the wellbore. To communicatively couple the fiber optic cable to devices at a surface of the wellbore, the fiber optic cable installed within the wellbore may be spliced to a section of fiber optic cable extending from the surface. One or more of the spliced fiber optic cables may have an extra length to ensure that a sufficient amount of fiber optic cable is present for the splicing operation. Techniques for managing extra length may include wrapping the extra length around the production tubing, but wrapping the extra length of fiber optic cable may put the fiber optic cable at greater risk of failure. Additionally, without the extra length of fiber optic cable, the fiber optic cables may not be sufficiently long for performance of a second splice if a first attempt fails.

### BRIEF DESCRIPTION OF THE DRAWINGS

FIG. 1 is a schematic view of an example of a wellbore system in a subsea environment according to one aspect of the present disclosure.

FIG. 2 is a side view of an example of a portion of a tubing string including a splice housing protector and a splice housing according to one aspect of the present disclosure.

FIGS. 3A-3C are side views of an example of a portion of a tubing string including a splice housing protector and a splice housing according to one aspect of the present disclosure.

FIG. 4 is a flowchart of an example of a process for splicing an uphole fiber optic cable with a downhole fiber optic cable according to one aspect of the present disclosure.

FIG. 5 is a bottom view of an example of a portion of a wellbore including a splice housing protector and a splice housing according to one aspect of the present disclosure.

FIG. 6 is a side view of an example of a splice housing according to one aspect of the present disclosure.

### DETAILED DESCRIPTION

Certain aspects and examples of the present disclosure relate to splicing an uphole fiber optic cable with a downhole fiber optic cable downhole in a wellbore. In an example, the two cables may be spliced by extending the uphole fiber optic cable in a downhole direction through a splice housing protector, bending the uphole fiber optic cable in an uphole direction to form a U-shape, and mating the uphole fiber optic cable and the downhole fiber optic cable with a splice housing. A splice housing is a device that may enable fiber optic communication between fiber optic cables, such as between the uphole fiber optic cable and the downhole fiber optic cable. A splice housing protector may be positioned around the splice housing and may include mating channels through which the fiber optic cables can extend and mate with the splice housing. The splice housing and splice housing protector may be positioned along a portion of a tubing string. Extending the uphole fiber optic cable through the splice housing protector and bending the uphole fiber optic cable in the uphole direction may provide a controlled mechanism for providing additional lengths of fiber optic cable that may extend in a downhole direction from the splice housing protector. The tail ends of the downhole fiber optic cable and the uphole fiber optic cable may each enter the splice housing through the splice housing protector and mate with ports in the splice housing to create a splice.

Bending the uphole fiber optic cable in the U-shape may allow for the tail ends of the uphole fiber optic cable and downhole fiber optic cable to be parallel with each other as the fiber optic cables enter the splice housing protector to mate with the splice housing. Bending the uphole fiber optic cable into the U-shape may also allow for the tail ends to be cut to appropriate lengths for performing the splice. In the event of an insufficient splice, a damaged portion of the uphole fiber optic cable or downhole fiber optic cable may be removed. The intact fiber optic cable may also be cut back so that its tail end position matches that of the shortened fiber optic cable. The splice housing may be translated in an uphole or downhole direction along the tubing string to allow the extra length of the uphole fiber optic cable to be fed into the splice housing for re-splicing.

In one example, the uphole fiber optic cable may descend from a tubing hanger positioned at a surface of the wellbore. The uphole fiber optic cable may be annealed, thus allowing for the uphole fiber optic cable to easily bend. In some examples, the downhole fiber optic cable may not be annealed and may not easily bend. The downhole fiber optic cable may mate with a first port of the splice housing after extending through the splice housing protector. The first port of the splice housing may be positioned at a downhole end of the splice housing protector. A second port of the splice housing may also be positioned at a downhole end of the splice housing protector. The uphole fiber optic cable may extend through the splice housing protector by entering a throughport at an uphole end of the splice housing protector and exiting the throughport at a downhole end of the splice housing protector. After extending through the splice housing protector, the uphole fiber optic cable may bend into a U-shape. The bend may enable an end of the uphole fiber optic cable to mate with the second port of the splice housing after entering the splice housing protector at the downhole end of the splice housing protector.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

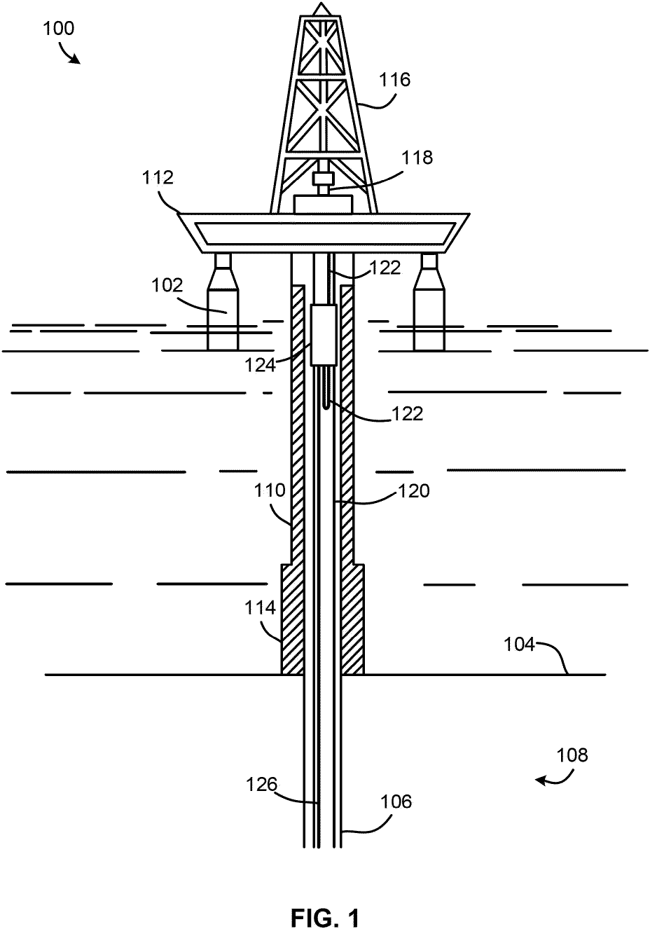

FIG. 1 is a schematic view of an example of a wellbore system 100 in a subsea environment according to one aspect of the present disclosure. A floating workstation 102 (e.g., an oil platform or an offshore platform) can be centered over a submerged oil or gas well located in a sea floor 104 having a wellbore 106. The wellbore 106 may extend from the sea floor 104 through a subterranean formation 108. A subsea conduit 110 can extend from a deck 112 of the floating workstation 102 into a wellhead installation 114. The floating workstation 102 can have a derrick 116 and a hoisting apparatus 118 for raising and lowering tools to drill, test, and complete the oil or gas well. The hoisting apparatus 118 may include a tubing hangar. In some examples, the processes described herein can be applied to a land-based environment for wellbore exploration, planning, and drilling.

A tubing string 120 can be lowered into the wellbore 106 of the oil or gas well as part of a completion operation of the oil or gas well. An uphole fiber optic cable 122 may descend in a downhole direction from the tubing hangar and extend through a splice housing protector 124. The splice housing protector 124 may be positioned around the tubing string 120. Upon exiting a downhole end of the splice housing protector 124, the uphole fiber optic cable 122 may bend in an uphole direction in a U-shape and enter the splice housing protector 124. A downhole fiber optic cable 126 may extend in an uphole direction and enter the splice housing protector 124.

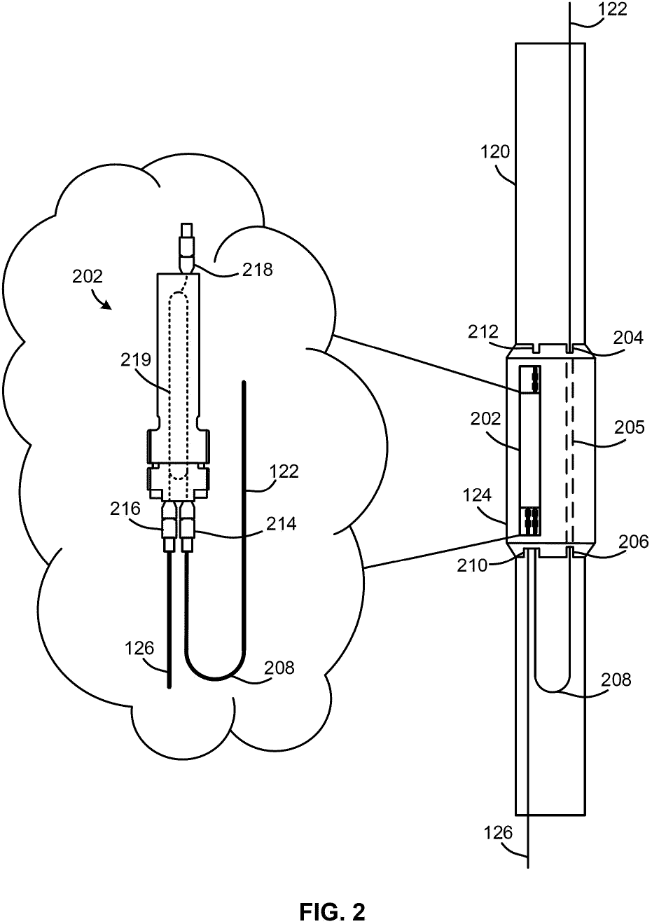

FIG. 2 is a side view of an example of a portion of the tubing string 120 including the splice housing protector 124 and the splice housing 202 according to one aspect of the present disclosure. The splice housing 202 may be positioned within the splice housing protector 124. The splice housing protector 124 may be positioned around the tubing string 120. The splice housing protector 124 may include a throughport 205 with an uphole opening 204 and a downhole opening 206. The splice housing protector 124 may also include a downhole mating channel 210 and an uphole mating channel 212 for feeding the uphole fiber optic cable 122 and the downhole fiber optic cable 126 into the splice housing 202. The splice housing 202 may include a first downhole port 214, a second downhole port 216, and a first uphole port 218. The downhole mating channel 210 may feed cables into the first downhole port 214 or the second downhole port 216. The uphole mating channel 212 may feed cables into the first uphole port 218. The splice housing 202 may include fiber optic coupling loops 219 that enable fiber optic communication between the first downhole port 214, the second downhole port 216, and the first uphole port 218.

The uphole fiber optic cable 122 may extend through the throughport 205 by entering the uphole opening 204 and exiting the downhole opening 206. After extending through the throughport 205, the uphole fiber optic cable 122 may bend in a U-bend 208 such that a downhole end of the uphole fiber optic cable 122 may enter the downhole mating channel 210. The uphole fiber optic cable 122 and downhole fiber optic cable 126 may be cut to an appropriate length to mate with the ports of the splice housing 202. In some examples, a wellbore operator may perform a fusion splice of the uphole fiber optic cable 122 and the fiber optic coupling loops 219. The fusion splice can include exposing the fibers inside the uphole fiber optic cable and fusing the fibers to the fiber optic coupling loops 219. In this manner, the uphole fiber optic cable 122 may be communicatively coupled with the first downhole port 214. The downhole fiber optic cable 126 may enter the splice housing protector 124 through the downhole mating channel 210. A fusion splice may then be performed between the downhole fiber optic cable 126 and the fiber optic coupling loops 219 in the splice housing 202. In this manner, the downhole fiber optic cable 126 may be communicatively coupled with the second downhole port 216. In an example, an optical integrity test may be used to determine if the uphole fiber optic cable 122 and downhole fiber optic cable 126 have optical integrity with one another. If there is optical integrity, a successful splice has been performed to create a combined fiber optic cable. The splice may be sealed and the combined fiber optic cable may be positioned within the wellbore 106.

In some examples, the splice housing 202 may include a first uphole port and a second uphole port. The first uphole port and second uphole port may align with the uphole mating channel 212. The downhole fiber optic cable 126 may be annealed and the uphole fiber optic cable 122 may not be annealed. The downhole fiber optic cable 126 may extend in an uphole direction through the throughport 205 of the splice housing protector 124 by entering the downhole opening 206 and exiting the uphole opening 204. The downhole fiber optic cable 126 may then bend into a downhole direction in a U-shape and enter the first uphole port of the splice housing 202 through the uphole mating channel 212. The uphole fiber optic cable 122 may descend from the tubing hanger and enter the second uphole port of the splice housing 202 through the uphole mating channel 212. Bending the downhole fiber optic cable 126 rather than the uphole fiber optic cable 122 may allow the tubing hanger, or hardware associated with the tubing hanger such as a cable shield, to protect the U-bend in the downhole fiber optic cable 126. For example, a channel may be machined into the tubing hanger to accommodate the U-bend in the downhole fiber optic cable 126.

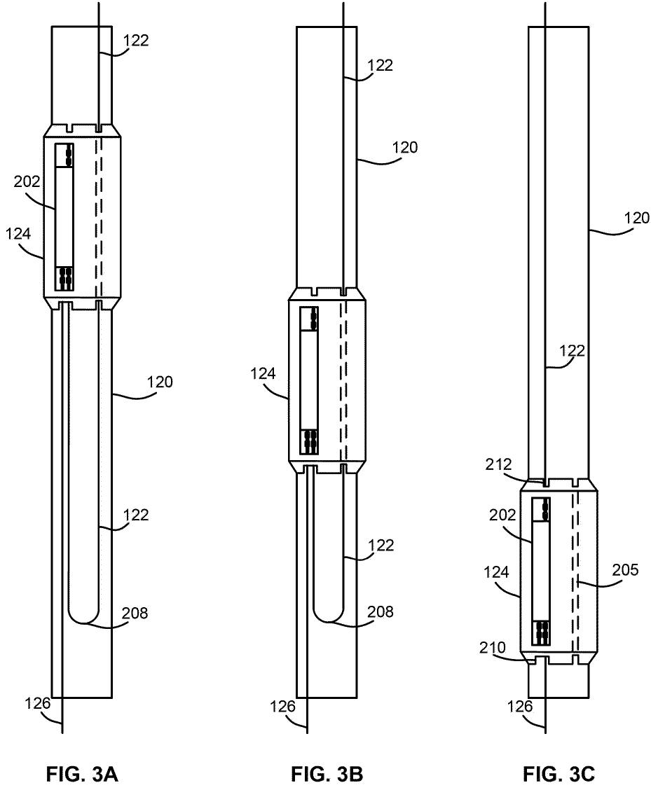

In one example, such as the one shown in FIG. 3A, the splice housing protector 124 may be located at a first position on the portion of the tubing string 120. A wellbore operator may perform a splice operation to splice the splice housing 202 to the uphole fiber optic cable 122 and the downhole fiber optic cable 126. If the splice operation is unsuccessful, the wellbore operator may cut the mating between the uphole fiber optic cable 122 and the first downhole port 214 as well as the mating between the downhole fiber optic cable 126 and the second downhole port 216. A damaged portion of the uphole fiber optic cable 122 or the downhole fiber optic cable 126 may be discarded.

As shown in FIG. 3B, the splice housing protector 124 may be moved in a downhole direction to a second location on the portion of the tubing string 120 using the extra length in the uphole fiber optic cable 122. The uphole fiber optic cable 122 may be re-mated with the first downhole port 214, and the downhole fiber optic cable 126 may be re-mated with the second downhole port 216. The wellbore operator may attempt to perform another splice operation to splice the uphole fiber optic cable 122 with the downhole fiber optic cable 126. If the splice operation is unsuccessful, the wellbore operator may cut the re-mating between the uphole fiber optic cable 122 and the first downhole port 214, and between the downhole fiber optic cable 126 and the second downhole port 216. A damaged portion of the uphole fiber optic cable 122 or the downhole fiber optic cable 126 may be discarded.

As shown in FIG. 3C, the splice housing protector 124 may be moved in a downhole direction to a third location on the portion of the tubing string 120 using the extra length in the uphole fiber optic cable 122. The uphole fiber optic cable 122 may be removed from the downhole mating channel 210 and the throughport 205 of the splice housing protector 124, removing the U-bend 208 in the uphole fiber optic cable 122. The uphole fiber optic cable 122 may extend through the uphole mating channel 212 of the splice housing protector 124 and mate with the first uphole port 218 of the splice housing 202. The downhole fiber optic cable 126 may be re-mated with the second downhole port 216. The wellbore operator may attempt to perform another splice operation to splice the uphole fiber optic cable 122 with the downhole fiber optic cable 126. Due to the U-bend 208 of the uphole fiber optic cable 122, as shown in FIGS. 3A and 3B, the wellbore operator may perform multiple splice operations on the fiber optic cables 122 and 126 without exhausting all slack in the uphole fiber optic cable 122.

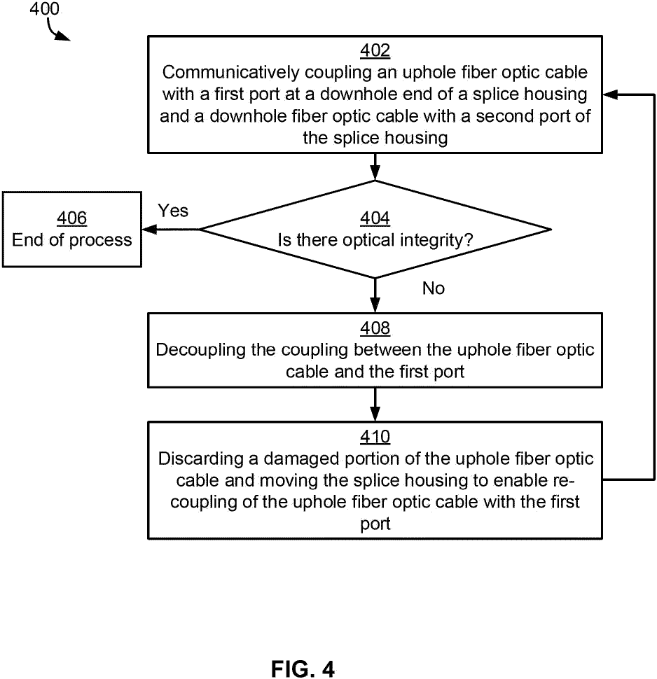

FIG. 4 is a flowchart of an example of a process 400 for splicing the uphole fiber optic cable 122 with the downhole fiber optic cable 126 according to one aspect of the present disclosure. Other examples can include more steps, few steps, different steps, or a different order of steps than is shown in FIG. 4. The steps of FIG. 4 are discussed below with reference to the components discussed above in relation to FIGS. 1-3.

At block 402, the process 400 may include communicatively coupling an uphole fiber optic cable 122 with a first port at a downhole end of a splice housing 202 and a downhole fiber optic cable 126 with a second port of the splice housing 202. For example, the first port at the downhole end may be the first downhole port 214 of FIG. 2, and the second port may be the second downhole port 216 of FIG. 2. In another example, the second port may be the first uphole port 218 of FIG. 2. The communicative coupling may be a mating between the fiber optic cables and the splice housing 202. The splice housing 202 may use fusion splicing, for example, to splice the uphole fiber optic cable 122 with the downhole fiber optic cable 126.

At block 404, the process 400 may include determining whether the uphole fiber optic cable 122 and downhole fiber optic cable 126 have optical integrity with the splice housing 202. For example, an optical integrity test may be used for determining optical integrity. The optical integrity test may determine if the uphole fiber optic cable 122 is sufficiently communicatively coupled with the downhole fiber optic cable 126. If there is optical integrity, a successful splice operation may have been performed and the process 400 may continue to block 406 to end the process 400. If there is not optical integrity, the splice operation may have been unsuccessful and the process may continue to block 408.

At block 408, the process 400 may include decoupling the coupling between the uphole fiber optic cable 122 and the first port. For example, the uphole fiber optic cable 122 may have been damaged during the splice and may need to be decoupled from the first port to perform another splice operation.

At block 410, the process 400 may include discarding a damaged portion of the uphole fiber optic cable 122 and moving the splice housing 202 to enable re-coupling of the uphole fiber optic cable 122 with the first port. After removing the damaged portion of the uphole fiber optic cable 122, the uphole fiber optic cable 122 may be re-coupled to the first port. The splice housing 202 may be translated in an uphole or downhole direction along the tubing string 120 to allow the uphole fiber optic cable 122 to be re-coupled to the first port. Alternatively, after removing the damaged portion of the uphole fiber optic cable 122, the splice housing 202 may first be translated in an uphole or downhole direction along the tubing string, the uphole fiber optic cable 122 may be re-bent into a U-bend, and the uphole fiber optic cable 122 may then be re-coupled to the first port. In some examples, if a length of the uphole fiber optic cable 122 is discarded such that the uphole fiber optic cable 122 no longer has the U-bend shown in FIG. 2 or does not have sufficient length to bend into a U-bend, the uphole fiber optic cable 122 may be coupled with a third port positioned at an uphole end of the splice housing 202.

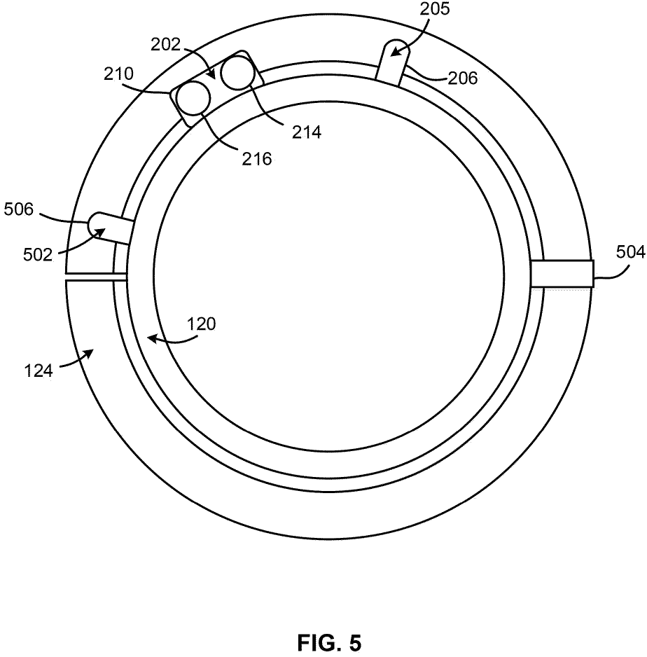

FIG. 5 is a bottom view of an example of a portion of a tubing string 120 including the splice housing protector 124 and the splice housing 202 according to one aspect of the present disclosure. The splice housing protector 124 may be positioned around the tubing string 120. The splice housing protector may include a throughport 205 with a downhole opening 206. The uphole fiber optic cable 122 may extend through the throughport 205 and exit at the downhole opening 206. This may allow the uphole fiber optic cable 122 to bend into a U-bend and enter the downhole mating channel 210 of the splice housing protector 124. The uphole fiber optic cable may mate with the first downhole port 214 of the splice housing 202. The first downhole port 214 and the second downhole port 216 may be positioned within the downhole mating channel 210.

In some examples, such as the one shown in FIG. 5, the splice housing protector 124 may include a second throughport 502. The downhole fiber optic cable 126 may extend in an uphole direction through the second throughport 502 by entering a downhole end 506 of the second throughport 502 and exiting an uphole end of the second throughport 502. This may enable the downhole fiber optic cable 126 to bend in a downhole direction into a U-bend and enter the uphole mating channel 212 of the splice housing protector 124. Alternatively, the downhole fiber optic cable 126 may enter the downhole mating channel 210 and mate with the second downhole port 216 of the splice housing 202.

In some examples, such as the one shown in FIG. 5, the splice housing protector 124 may include a clamshell hinge 504. The clamshell hinge 504 may enable easier installation of the splice housing protector 124 around the tubing string 120.

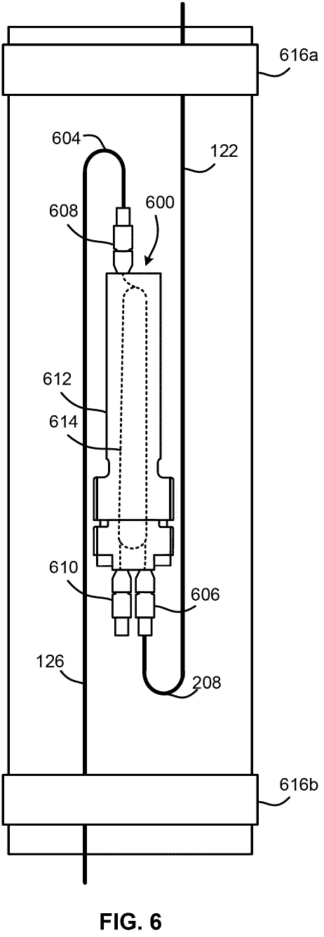

FIG. 6 is a side view of an example of a splice housing 600 according to one aspect of the present disclosure. The splice housing 600 may be positioned within a splice housing protector (not pictured) with a second throughport 502, such as the splice housing protector 124 shown in FIG. 5. The splice housing 600 may include a first port 606, a second port 608, and a third port 610. The first port 606 and the third port 610 may be positioned on a downhole end of the splice housing 600. The second port 608 may be positioned on an uphole end of the splice housing 600. The splice housing 600 may also include a splice body 612, which houses fiber optic coupling loops 614 to generate a fiber optic coupling between the uphole fiber optic cable 122 and the downhole fiber optic cable 126.

The uphole fiber optic cable 122 may extend in a downhole direction past the splice housing 600, bend into a U-bend 208, and extend in an uphole direction to mate with the first port 606. The downhole fiber optic cable 126 may extend in an uphole direction past the splice housing 600, bend into a U-bend 604, and extend in a downhole direction to mate with the second port 608. In some examples, the downhole fiber optic cable 126 may extend in an uphole direction and mate with the third port 610. Cable clamps 616a and 616b may be used to clamp portions of the fiber optic cables to the tubing string 120. For example, a portion of the downhole fiber optic cable 126 that extends past an uphole end of the splice housing 600 may be clamped with cable clamp 616a to the tubing string 120 for support such that the downhole fiber optic cable 126 can bend into the U-bend 604.

If the splice body 612 performs an insufficient splice operation, the uphole fiber optic cable 122 may be de-coupled from the first port 606 and the downhole fiber optic cable 126 may be de-coupled from the second port 608. Damaged portions of the uphole fiber optic cable 122 or downhole fiber optic cable 126 may be discarded. The uphole fiber optic cable 122 may be re-bent in an uphole direction into the U-bend 208 to feed the uphole fiber optic cable 122 into the first port 606 for a re-mating. The downhole fiber optic cable 126 may be re-bent in a downhole direction into the U-bend 604 to feed the downhole fiber optic cable 126 into the second port 608 for a re-mating. Because the U-bends may be re-bent, the splice housing 600 may remain in place for performing an additional splice operation. After re-mating, the splice body 612 may perform the additional splice operation.

In some aspects, systems, methods, and apparatus for performing downhole splices of fiber optic cables are provided according to one or more of the following examples:

Example #1: A system may include a splice housing positionable along a portion of tubing, a splice housing protector positionable around the splice housing, an uphole fiber optic cable, and a downhole fiber optic cable. The uphole fiber optic cable may be positionable to extend through the splice housing protector and mate with a first port of the splice housing at a downhole end of the splice housing protector. The downhole fiber optic cable may be positionable to mate with a second port of the splice housing in the splice housing protector. The splice housing may be positionable to splice the uphole fiber optic cable and downhole fiber optic cable.

Example #2: The system of Example #1 may feature the uphole fiber optic cable being extendable through the splice housing protector at a length sufficient (i) to discard a portion of the uphole fiber optic cable upon detection of an insufficient splice and (ii) to re-mate the uphole fiber optic cable with the first port of the splice housing.

Example #3: The system of any of Examples #1-2 may feature the uphole fiber optic cable being positionable to bend in an uphole direction in a U-shape after extending through the splice housing protector such that a tail end of the uphole fiber optic cable is parallel with a tail end of the downhole fiber optic cable.

Example #4: The system of any of Examples #1-3 may feature the second port of the splice housing being positionable at a downhole end of the splice housing protector.

Example #5: The system of any of Examples #1-4 may feature the downhole fiber optic cable being positionable to extend in an uphole direction through the splice housing protector and mate with the second port of the splice housing at an uphole end of the splice housing protector.

Example #6: The system of any of Examples #1-5 may feature the downhole fiber optic cable being positionable to bend in a downhole direction in a U-shape after extending in the uphole direction through the splice housing protector.

Example #7: The system of any of Examples #1-6 may feature the splice housing protector further including fiber optic coupling loops for enabling the splice between the uphole fiber optic cable and the downhole fiber optic cable.

Example #8: A method may include communicatively coupling, to a splice housing positionable along a portion of tubing and in a splice housing protector, an uphole fiber optic cable with a first port at a downhole end of the splice housing and a downhole fiber optic cable with a second port of the splice housing. The method may include determining whether the uphole fiber optic cable and the downhole fiber optic cable have optical integrity with the splice housing. The method may include, in response to determining that the uphole fiber optic cable and the downhole fiber optic cable do not have optical integrity, decoupling the coupling between the uphole fiber optic cable and the first port. The method may include discarding a damaged portion of the uphole fiber optic cable to enable re-coupling of the uphole fiber optic cable with the first port. The method may include translating the splice housing protector along the portion of tubing using a slack in the uphole fiber optic cable. The method may include re-coupling the uphole fiber optic cable to the first port.

Example #9: The method of Example #8 may include extending the uphole fiber optic cable through the splice housing protector at a length sufficient to discard the damaged portion of the uphole fiber optic cable prior to re-coupling the uphole fiber optic cable with the first port of the splice housing.

Example #10: The method of any of Examples #8-9 may include bending the uphole fiber optic cable in an uphole direction in a U-shape after extending the uphole fiber optic cable through the splice housing protector such that a tail end of the uphole fiber optic cable is parallel with a tail end of the downhole fiber optic cable.

Example #11: The method of any of Examples #8-10 may feature the second port of the splice housing being positioned at a downhole end of the splice housing protector.

Example #12: The method of any of Examples #8-11 may include extending the downhole fiber optic cable in an uphole direction through the splice housing protector. The method may include mating the downhole fiber optic cable with the second port of the splice housing at an uphole end of the splice housing protector.

Example #13: The method of any of Examples #8-12 may include bending the downhole fiber optic cable in a downhole direction in a U-shape after extending in the uphole direction through the splice housing protector such that a tail end of the downhole fiber optic cable is parallel with a tail end of the uphole fiber optic cable.

Example #14: The method of any of Examples #8-13 may feature the splice housing protector further including fiber optic coupling loops for enabling of the splice between the uphole fiber optic cable and the downhole fiber optic cable.

Example #15: A splice housing protector may include a first throughport with a first opening at an uphole end and a second opening at a downhole end such that an uphole fiber optic cable is positionable to extend through the first throughport along a portion of tubing within the splice housing protector. The splice housing protector may include at least one mating channel positionable at an end of the splice housing protector to receive an end of the uphole fiber optic cable and an end of a downhole fiber optic cable such that the end of the uphole fiber optic cable and the end of the downhole fiber optic cable are positionable within the at least one mating channel to communicatively couple with a splice housing positionable inside the splice housing protector.

Example #16: The splice housing protector of Example #15 may feature a second throughport with a first opening at a downhole end and a second opening at an uphole end such that the downhole fiber optic cable is positionable to extend through the second throughport by entering the first opening at the downhole end and exiting the second opening at the uphole end.

Example #17: The splice housing protector of any of Examples #14-16 may feature a first mating channel of the at least one mating channel being positionable at an uphole end of the splice housing protector.

Example #18: The splice housing protector of any of Examples #14-17 may feature a second mating channel of the at least one mating channel being positionable at a downhole end of the splice housing protector.

Example #19: The splice housing protector of any of Examples #14-18 may feature a clamshell hinge positionable to install the splice housing protector around the tubing.

Example #20: The splice housing protector of any of Examples #14-19 may feature the at least one mating channel including an individual mating channel that is positionable to receive at least a portion of the uphole fiber optic cable and at least a portion of the downhole fiber optic cable such that the uphole fiber optic cable is parallel to the downhole fiber optic cable.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a splice housing positionable along a portion of tubing;
a splice housing protector positionable around the splice housing;
an uphole fiber optic cable positionable to extend through the splice housing protector and mate with a first port of the splice housing at a downhole end of the splice housing protector; and
a downhole fiber optic cable positionable to mate with a second port of the splice housing in the splice housing protector, the splice housing being positionable to splice the uphole fiber optic cable and downhole fiber optic cable.

2. The system of claim 1, wherein the uphole fiber optic cable is extendable through the splice housing protector at a length sufficient (i) to discard a portion of the uphole fiber optic cable upon detection of an insufficient splice and (ii) to re-mate the uphole fiber optic cable with the first port of the splice housing.

3. The system of claim 1, wherein the uphole fiber optic cable is positionable to bend in an uphole direction in a U-shape after extending through the splice housing protector such that a tail end of the uphole fiber optic cable is parallel with a tail end of the downhole fiber optic cable.

4. The system of claim 3, wherein the second port of the splice housing is positionable at a downhole end of the splice housing protector.

5. The system of claim 1, wherein the downhole fiber optic cable is positionable to extend in an uphole direction through the splice housing protector and mate with the second port of the splice housing at an uphole end of the splice housing protector.

6. The system of claim 5, wherein the downhole fiber optic cable is positionable to bend in a downhole direction in a U-shape after extending in the uphole direction through the splice housing protector.

7. The system of claim 1, wherein the splice housing protector further comprises fiber optic coupling loops for enabling the splice between the uphole fiber optic cable and the downhole fiber optic cable.

8. A method comprising:
communicatively coupling, to a splice housing positionable along a portion of tubing and in a splice housing protector, an uphole fiber optic cable with a first port at a downhole end of the splice housing and a downhole fiber optic cable with a second port of the splice housing;
determining whether the uphole fiber optic cable and the downhole fiber optic cable have optical integrity with the splice housing;
in response to determining that the uphole fiber optic cable and the downhole fiber optic cable do not have optical integrity, decoupling the coupling between the uphole fiber optic cable and the first port;
discarding a damaged portion of the uphole fiber optic cable to enable re-coupling of the uphole fiber optic cable with the first port;
translating the splice housing protector along the portion of tubing using a slack in the uphole fiber optic cable; and
re-coupling the uphole fiber optic cable to the first port.

9. The method of claim 8, further comprising:
extending the uphole fiber optic cable through the splice housing protector at a length sufficient to discard the damaged portion of the uphole fiber optic cable prior to re-coupling the uphole fiber optic cable with the first port of the splice housing.

10. The method of claim 9, further comprising:
bending the uphole fiber optic cable in an uphole direction in a U-shape after extending the uphole fiber optic cable through the splice housing protector such that a tail end of the uphole fiber optic cable is parallel with a tail end of the downhole fiber optic cable.

11. The method of claim 8, wherein the second port of the splice housing is positioned at a downhole end of the splice housing protector.

12. The method of claim 8, further comprising:
extending the downhole fiber optic cable in an uphole direction through the splice housing protector; and
mating the downhole fiber optic cable with the second port of the splice housing at an uphole end of the splice housing protector.

13. The method of claim 12, further comprising:
bending the downhole fiber optic cable in a downhole direction in a U-shape after extending in the uphole direction through the splice housing protector such that a tail end of the downhole fiber optic cable is parallel with a tail end of the uphole fiber optic cable.

14. The method of claim 10, wherein the splice housing protector further comprises fiber optic coupling loops for enabling of the splice between the uphole fiber optic cable and the downhole fiber optic cable.

15. A splice housing protector comprising:
a first throughport with a first opening at an uphole end and a second opening at a downhole end such that an uphole fiber optic cable is positionable to extend through the first throughport along a portion of tubing within the splice housing protector; and
at least one mating channel positionable at an end of the splice housing protector to receive an end of the uphole fiber optic cable and an end of a downhole fiber optic cable such that the end of the uphole fiber optic cable and the end of the downhole fiber optic cable are positionable within the at least one mating channel to communicatively couple with a splice housing positionable inside the splice housing protector.

16. The splice housing protector of claim 15, further comprising:
a second throughport with a first opening at a downhole end and a second opening at an uphole end such that the downhole fiber optic cable is positionable to extend through the second throughport by entering the first opening at the downhole end and exiting the second opening at the uphole end.

17. The splice housing protector of claim 16, wherein a first mating channel of the at least one mating channel is positionable at an uphole end of the splice housing protector.

18. The splice housing protector of claim 17, wherein a second mating channel of the at least one mating channel is positionable at a downhole end of the splice housing protector.

19. The splice housing protector of claim 15, further comprising:
a clamshell hinge positionable to install the splice housing protector around the tubing.

20. The splice housing protector of claim 15, wherein the at least one mating channel comprises an individual mating channel that is positionable to receive at least a portion of the uphole fiber optic cable and at least a portion of the downhole fiber optic cable such that the uphole fiber optic cable is parallel to the downhole fiber optic cable.
